(19) United States
(12) Patent Application Publication
(10) Pub. No.: US 2013/0196141 A1
(43) Pub. Date: Aug. 1, 2013

(54) PROCESS FOR INTERNALLY COATING FUNCTIONAL LAYERS WITH A THROUGH-HARDENED MATERIAL

(71) Applicants: Robert Vassen, Herzogenrath (DE); Frank Vondahlen, Wassenberg (DE); Doris Sebold, Aldenhoven (DE); Daniel Emil Mack, Koeln (DE); Georg Mauer, Toenisvorst (DE); Detlev Stoever, Niederzier (DE)

(72) Inventors: Robert Vassen, Herzogenrath (DE); Frank Vondahlen, Wassenberg (DE); Doris Sebold, Aldenhoven (DE); Daniel Emil Mack, Koeln (DE); Georg Mauer, Toenisvorst (DE); Detlev Stoever, Niederzier (DE)

(21) Appl. No.: 13/640,401

(22) PCT Filed: Apr. 5, 2011
(86) PCT No.: PCT/DE2011/000370

§ 371 Date: Nov. 15, 2012

(30) Foreign Application Priority Data
Apr. 16, 2010 (DE) 10 2010 015 470.9

(51) Int. Cl. B28B 19/00; F01D 5/28

(52) U.S. Cl. CPC B28B 19/00; F01D 5/288
USPC 428/312.6; 427/255.12; 428/312.8

(57) ABSTRACT

Provided is a method for internally coating the pores of a porous functional coating made of a base material with a hardening material that reduces the diffusion of the base material and/or the reactivity of the base material with the environment thereof. The hardening material is deposited from the gas phase onto the interior surfaces of the pores. It was recognized that by depositing hardening material from the gas phase, it can be introduced much deeper into the pore system of the functional coating than had been possible according to the prior art. This applies in particular when the hardening material is not itself introduced into the pore s stem, but rather one or two precursors thereof, and from said precursors the actual hardening material forms at the internal surfaces of the pores.

The invention relates to a method for internally coating functional coatings with a hardening material.

### PRIOR ART

Components for high-temperature use, such as turbine blades for gas turbines, are made of base materials selected according to the mechanical requirements placed on the component. This can include heat-resistant steels, for example. Since according to thermodynamic fundamentals the efficiency of a gas turbine increases considerably with increasing operating temperature, there arises the necessity of increasing the operating temperature beyond the maximum temperature at which the base material remains stable. To accomplish this, the component is provided with a porous thermal insulation coating.

In general, during sustained high temperature use such a thermal insulation coating is subject to irreversible aging until it finally flakes off of the component. The component must then be removed, which is a complicated process, and re-coated assuming it has not already ultimately failed due to the lack of a thermal insulation coating in areas.

DE 102 00 803 A1 discloses a method for adding a foreign phase comprising a hardening material to the base material of the thermal insulation coating. Methods are disclosed by which such a hardening material can be added during the actual manufacture of the thermal insulation coating. However, there is also a need to be able to introduce the hardening material into the already existent pore system of the base material afterward. It should be possible to optimize the processes of applying base material and hardening material independent of one another, and it is desirable to be able to replace hardening material that has worn away during high temperature use. To this end, DE 102 00 803 A1 discloses a method in which the hardening material is infiltrated into the pore system of the base material as a very fine powder in a liquid phase using capillary forces.

The penetration depth of the hardening material into the pore system of the base material obtainable through this method and the improvement in durability of thermal insulation coatings achievable with the hardening material is discernible, but there is without a doubt still room for improvement.

### OBJECTIVE AND SOLUTION

Therefore, the objective of the invention is to provide a method for introducing the hardening material deeper into the pore system of the base material and for doing so in such a way that a greater effect on the durability of the layer is seen.

This objective is accomplished according to the invention by a method according to the main claim. Further advantageous embodiments can be found in the dependent claims which refer to the main claim.

### OBJECT OF THE INVENTION

In the context of the invention, a method was developed for internally coating the pores of a porous functional coating made up of a base material with a hardening material that reduces the diffusion of the base material and/or the reactivity of the base material with the environment thereof. According to the invention, the hardening material is deposited from the gas phase onto the interior surfaces of the pores.

It was recognized that by depositing hardening material from the gas phase, it can be introduced much deeper into the pore system of the functional coating than had been possible according to the prior art.

Thermal insulation coatings, protective coatings, run-in coatings, and other functional coatings for high-temperature use are designed to be porous so that, on one hand, they adhere well to the coated component and, on the other hand, they can react to temperature changes with a tolerance for expansion. At operating temperatures of 1000° C. or more, and even frequently 1300° C. or more, stresses in the functional coating begin to relax. Therefore, it is advantageous to select a base material with a melting temperature above 1000° C., preferably above 2000° C. When the component cools down from its operating temperature, the component contracts faster than the functional coating because it generally has a larger thermal coefficient of expansion than the functional coating. It was found that the porosity and microscopic cracks in the functional coating provide the functional coating with room within which the mechanical stress in the functional coating and between the functional coating and the component that sets up during cooling can be at least partially compensated.

Therefore, it is advantageous to select a base material with a porosity of 5 vol % or more, preferably between 15 and 20 vol %, for the coating according to the invention. Particularly advantageous for coatings using this method are base materials with a pore distribution with pore diameters of less than 1 micrometer and high aspect ratios (depth of the pores). Such pore distributions are frequently found in thermally sprayed coatings.

The method according to the invention is particularly suited for a porous base material having a pore distribution in which the pores having a diameter of less than 1 micrometer make up typically more than 40% of the porosity, in particular more than 60%. This means that a majority of the porosity is in the range of less than 1 micrometer. A similar pore size distribution is also found in EB-PVD layers, in other words base materials that are applied using the Electron Beam Physical Vapor Deposition method. In general, all thermal insulation coatings can be used as base coatings.

As the duration of operation increases, the base material of the functional coating generally tends to sinter. The grains of the base material touch via contact surfaces that have very curved areas, in other words, short radii of curvature. At operating temperature, atoms or molecules of the base material diffuse more easily. The base material tends to diffuse from the contact surface into the curvature zone in order to flatten the curvature and thereby minimize the potential energy of this curvature zone. This enlarges the contact surface. This effect is amplified through material transport along the surface of the curvature zone to the point of maximum curvature, which is where the most potential energy can be dissipated by the displaced material. This leads to a permanent enlargement of the contact surfaces between the grains and, to some extent, to clogging of the pores of the material. This increases the modulus of elasticity of, and thereby the stresses in, the material in the layer, and at the same time reduces the ability to reduce stress through microcracks. The material of the functional coating becomes less and less resistant to this load and finally flakes off when the stored elastic energy exceeds the rate of energy release of the system. Because the base material is compacted due to the increasing clogging of the pores, the aging process is observed macroscopically as a progressive shrinking (sinter-shrinking) of the base material.

This is where the effects of the invention are seen. The hardening material, which is introduced very deeply into the pore system of the functional coating forms a barrier against the diffusion of atoms or molecules of the base material in the curvature zones between the grains, and at the same time protects the base material from aggressive operating atmospheres. In addition, it has an advantageously slow diffusion constant for atoms or molecules of the base material. It should be less than 10⁻¹⁵ m²/s to be advantageous.

In thermally sprayed base coatings, for example, coatings can be applied easily up depths of 50 micrometers. In the process, what has been found to be particularly advantageous is a coating method based on the ALD process (Atomic Layer Deposition).

It is also advantageous for the hardening material to have a low self-diffusion coefficient. Since this frequently correlates with the melting point, the materials selected here must have high melting points, preferably above 2000° C.

It is also advantageous for the hardening material to be largely inert relative to the base material; in this case, a low solubility is beneficial. With regard to ambient conditions in particular, it is advantageous for the material to be inert relative to the atmosphere near the functional coating under operating conditions. For example, in an operating atmosphere consisting of air, oxide materials are advantageous as hardening materials.

In general, the hardening material not only penetrates deeper into the pore system, but also promotes a better effect there than the hardening material introduced in powder form from the liquid phase according to the prior art.

In general, the functional coatings produced by way of the method according to the invention have a high density (porosities of less than 2 vol %), a high degree of homogeneity in layer thickness and a globular to columnar grain structure depending on the coating temperature. It is the first two features of the coating which are usually not achieved using prior art liquid phase infiltration (such as sol-gel) due to the different radii of curvature of the surfaces and the different capillary forces associated therewith. As regards the invention, a homogeneous layer thickness is understood as the effect that the difference between the layer thickness at the pore entrance and the thickness at a depth of a multiple of the pore diameter is very low, in particular less than 10%, and that it is low even for pores having a pore diameter of less than 1 μm (sub-micrometer range). It is also difficult to achieve high density without cracks; it would typically require high sintering temperatures for alternative application methods.

According to the invention, it is possible to produce internal coatings of porous thermal insulation coating systems made up of oxide ceramic materials (zirconium dioxide with various stabilizers (such as YSZ), pyrochlores, Perovskites, aluminates, spinels, silicates, and the like) with stable materials (oxides, aluminum oxides, zirconium oxides, pyrochlores, Perovskites, aluminates, spinels, and the like).

It is further possible to internally coat porous protection layer systems of ceramic (fiber-composite) materials (Environmental Barrier Coatings or EBCs). The oxide ceramic protection coating materials can include: zirconium dioxide with various stabilizers (such as YSZ), pyrochlores, Perovskites, aluminates, spinels, silicates, and the like. The infiltration materials are advantageously selected from the group of oxides, special aluminum oxides, zirconium oxides, pyrochlores. Perovskite, aluminates, spinels, among others.

The method according to the invention also makes it possible to apply internal coatings, such as thermal insulation coatings, onto complex components (turbine blades, combustion chamber elements, or transition pieces of gas turbines), in such a way that the internal coating has the largest thickness at the point where the hottest regions occur.

The diffusion barrier effect of the manufactured functional coating depends very much on how well the very curved areas at the contact surfaces at which the grains of the base material touch are layered with the hardening material. The smallest units of hardening material that can be introduced through the gas phase include clusters, molecules, or even individual atoms, for example. The curved areas of the contact surfaces can be much more densely sealed off against diffusion and corrosion by way of these extremely small units, even in comparison with very finely ground powder grains.

In a simple embodiment, the hardening material can be introduced into the pores through PVD (physical vapor deposition). In this case, inner surface areas of the pores that are in the direct line of sight of the source of the hardening material (line-of-sight coating) can be coated with the hardening material, essentially.

In an advantageous embodiment of the invention, the hardening material is introduced into the pores in an inert gas stream. In this way, the area of the pore system that can be coated using PVD is expanded beyond direct line of sight (high flow PVD).

In an especially advantageous embodiment of the invention, a precursor is introduced into the pores, the precursor reacting with the base material at the inner surfaces of the pores to form the hardening material and/or decomposing there to form the hardening material. In this regard, a suitable precursor is sufficiently volatile, is stable in the gas phase, and only reacts with the substrate and with the growing surface to form an inert intermediate product. In that case, the hardening material can traverse wide distances beyond the direct line of sight to the source within the pore system before it hits a point on the base material and lodges itself there. The reaction or decomposition can be triggered by the base material being at an elevated temperature and thereby providing the incident hardening material with the activation energy for the reaction or decomposition, for example. This embodiment is a variation of the CVD process (Chemical Vapor Deposition). Internal coatings of pores can be achieved in the sub-millimeter range. Here, sub-millimeter range means pore diameters of less than 1 mm but larger than one micrometer (>1 μm).

In another especially advantageous embodiment of the invention, a first precursor PA is first introduced into the pores, that then builds up on the base material at the inner surfaces of the pores and/or reacts therewith so that a coating A is formed. In the process, the precursor PA does not accumulate on coating A, and also does not react with it. Then, a second precursor PB is introduced into the pores, the second precursor accumulating on coating A and/or reacting with it so that coating AB is formed. In the process, precursor PB does not accumulate on coating AB and also does not react with it. This embodiment is a variation of the ALD process (Atomic Layer Deposition).

With the aid of an ALD process, it is advantageously possible to also deeply coat a base material that has pore diameters in the range of less than 1 μm (sub-micrometer range).

It was recognized that in coatings according to the prior art using only one precursor there is a tendency for the parts of the pore system closest to the source of the precursor to become particularly thickly coated internally. Pores with diameters in the sub-micrometer range are quickly clogged in this way, such that the deeper areas of the pore system are no longer reachable by the precursor. Pores with diameters in this order of magnitude typically occur in plasma-sprayed ceramic layers, such as yttrium-stabilized zirconium oxide (YSZ), for example.

The embodiment with two precursors, as described above, can also internally coat pores in the sub-micrometer range. Independent of the concentration at which precursor PA is present at the base material, only one layer of coating A grows thereon. Also independent of the concentration at which precursor PB is present at layer A, only one layer of coating AB arises. Thus, the two precursors can be present at sufficiently high enough concentrations to penetrate into the pore system to as yet unreached depths and there effect an internal coating of the pores.

For example, the precursor PA can be chemisorbed onto inner surfaces of the pores or it can react there with surface groups, for example hydroxyl groups. If the surface is completely coated with a layer of precursor PA or a reaction product thereof, and thereby saturated, it no longer changes even if further precursor PA is present. Similarly, when layer A has been converted completely to layer AB the surface no longer changes by the presence of precursor PB. If a long enough time has passed after presenting precursors PA and PB until they have penetrated to all inner surfaces of the pore system, in the ideal case, the amount of the deposited material is independent of the precise time frame and concentration at which precursors PA and PB are presented. The growth of the coating on the inner surfaces is then self-controlling.

Basically, gases, volatile liquids, and solids are included as possible precursors PA and PB. The vapor pressure should be sufficiently high enough to guarantee an effective transport of precursors to the pore system via the gas phase.

Examples of precursors include halogens, alkyl compounds, or alkoxides. Metal-organic compounds as precursors react at lower temperatures, which is advantageous, such that the base material does not have to be heated up as much to thermally activate the reaction. The above-mentioned materials can be presented as preferred precursors PA.

Examples of non-metallic precursors that are generally used as precursors PB include water, molecular oxygen, ozone, and ammonia.

In another advantageous embodiment of the invention, if more than one layer of hardening material is to be applied, after the formation of layer AB, precursor PA is again introduced into the pores so that it accumulates onto layer AB and/or reacts therewith. An ABA layer is then formed. Precursor PA does not accumulate on this layer nor react with it.

Then, precursor PB can be re-introduced into the pores so that it accumulates onto layer ABA and/or reacts therewith. In the process, an ABAB layer is formed, Precursor PB does not accumulate onto layer ABAB nor react with it.

The alternating introduction of precursors PA and PB into the pores can be repeated cyclically so that layers of tailored thicknesses can be produced, the thickness depending only on the number of cycles. A cycle can in general last between 0.5 and a few seconds, wherein about 0.1 to 3 Å of hardening material are deposited per cycle.

The layer thickness achievable in a practical amount of time tends to decrease with increasing depths within the pore system because the time needed for the precursors to diffuse at a point in the pore system increases with the square of the depth. On the other hand, in many applications, the temperature load also increases with increasing depths since the component is heated from one side only. Thus, in general, the functional coating is subject to a temperature gradient.

For this case, a particularly thick inner coating can be achieved in the part of the functional coating that is the hottest during high temperature use. In the process, due to the layered dosing of the coating thickness, it is simultaneously guaranteed that the pores are not completely clogged. In turn, the consequence of this is that even deep pores with high aspect ratios can be very evenly internally coated.

Al₂O₃ is an example of a hardening material that can be deposited from two precursors PA and PB. The metal-organic compound tri-methyl aluminum Al(CH₃)₃ (TMA) is used as the first precursor PA, the molecules of which react with the hydroxyl groups on the internal surfaces of pores in oxide base materials until these surfaces are saturated,

After flushing the reaction chamber with the inert gas argon, steam is introduced as the second precursor PB. The water molecules in turn react with the previously generated methyl surface groups to form the hardening material Al₂O₃ and at the same time form new hydroxyl groups at the surface, and in turn, precursor PA is now able to react with these groups and introduce the next cycle.

The reactions proceed according to the following equations:

2Al(CH₃)₃+2(OH*)→2[AlO—(CH₃*)₂]2CH₄ (PA)

3H₂O+2[AlO—(CH₃*)₂]→2[½(Al₂O₃)—OH*]+4CH₄ (PB)

2Al(CH₃)₃+3H₂O—Al₂O₃+6CH₄ (overall)

Here, the asterisk (*) identifies functional hydroxyl OH—) and methyl (CH3) groups on the surface. The methane is removed each time by flushing with inert gas and pumping down.

Thus, in a particularly preferred embodiment of the invention, in general, a base material is selected that forms functional hydroxyl groups at the inner surfaces of the pores. Then, precursors PA and PB can be selected such that the coatings A and ABA both form functional methyl groups at the surfaces thereof and/or such that coatings AB and ABAB each form functional hydroxyl groups at the surfaces thereof.

In the example of Al₂O₃, the base material was held at a temperature of 350° C. It is advantageous for the base material to be held at a temperature of between 200 and 500° C. Two liquid reservoirs were used, each at a temperature of 19° C., to introduce the precursors TMA (PA) and H₂O (PB). The vapor pressure of both precursors proved to be sufficient in this case. For other precursors, it can be advantageous for them to be presented at a higher temperature of between 19 and 80° C. It can also be necessary to force them from the liquid reservoir and convert them to the gas phase by having a suitable inert flushing gas flow through the reservoir, for example.

Each application of precursor PA or PB lasts approximately 3 seconds. Typical values for this material system lie between 1 and 20 seconds. Including the argon flushing, each cycle lasts 30 seconds. After a total of 150 cycles, a 50 nm thick Al₂O₃ coating was applied in the entry area of the pore system. In general, it is advantageous for the hardening material to be deposited at a coating thickness of between 1 and 200 nm.

In another advantageous embodiment of the invention, the accumulation or reaction of precursor PB onto coating A or ABA proceeds in preference over the reaction of precursor PB with precursor PA. Ideally, precursor PB does not react at all with precursor PA. Then, the two precursors PA and PB can be introduced to the pore system in alternating fashion by moving the same vacuum chamber for the area of the functional coating to be hardened back and forth between the sources of precursors PA and PB. Normally, the vacuum chambers and/or the pore system are flushed with an inert gas between the introduction of precursor PA and the introduction of precursor PB in order to prevent gas phase reactions between precursors PA and PB. This step can be ignored if the precursors PA and PB either do not react with one another at all or only give off, in the process of reacting, reaction products that do not disturb the internal coating on the pore system.

The base material of the functional coating can be applied to the component to be coated using thermal spraying processes (such as Atmospheric Plasma Spraying, APS), PVD (Physical Vapor Deposition, and electron beam PVD in particular), CVD (Chemical Vapor Deposition), or sintering processes.

Since the structures of the base material usually differ due to the different methods, the internal coating must also be adjusted. For example, the columnar structure of PVD coatings allows for a relatively short coating time to be selected.

In another advantageous embodiment of the invention, a crystallization-promoting material is selected as the hardening material. In coating systems in gas turbines, many times damages occur due to deposits (typically alkali-rich and alkaline earth-rich aluminosilicates and to some degree iron oxide, CMAS to CaMgAlSi) on the outside of the functional coating becoming molten and penetrating into the pores of the functional coating. If it is possible to crystallize these molten materials early on, the extent of damage caused by them to the functional coating can be reduced. In particular, titanium oxides, aluminum oxides, rare earth oxides, and pyrochlores are used as crystallization-promoting materials. Here, it is once again advantageous if the hardening material coating is the thickest at the surface of the functional coating facing the deposits since the threat posed due to the deposits is also the greatest there. For example, a YSZ thermal insulation coating can be provided on a turbine blade with a 50 nm thick TiO₂ internal coating. Al₂O₃ is also suitable as a crystallization-promoting material.

In another advantageous embodiment of the invention, a protection coating system (Environmental Barrier Coating, or EBC) for a ceramic material, in particular a fiber-composite material, is selected as the base material. Both oxide fiber-composite materials (such as systems reinforced with aluminum oxide fibers) and non-oxide fiber-composite materials (such as Si/SiC) as well as monolithic ceramic materials (for example Si₃N₄) require protective coating systems for long-term operation in gas turbine atmospheres. These are applied using thermal spraying methods similar to those for thermal insulation coating systems, and therefore have a similar porous structure. Therefore, they compact similar to thermal insulation coating systems during high temperature use; they lose their tolerance for expansion and, therefore, their good mechanical properties. Their life span can be advantageously extended through internal coating with the hardening material according to the invention.

If a new material is to be used as the hardening material, in general, it is specified which end product, in other words which hardening material, is ultimately to be deposited onto the internal surfaces of the pores based on the advantageous properties of the material. In applying the method according to the invention, then, the main task is finding one or two suitable precursors through which the hardening material can be formed and deposited.

Especially advantageous embodiments of the internal coating according to the invention include an ALD coating of YSZ-coated turbine blades with Al₂O₃ and an internal ALD coating of dual-layered thermal insulation coating systems with ((partially) stabilized) zirconium dioxide consisting of a YSZ layer on a bond coat and a pyrochlore phase on top, among other things.

### SPECIFIC DESCRIPTION

Below, the object of the invention is explained in more detail with the aid of figures and detailed manufacturing conditions for different internal coatings; the object of the invention is not limited by this description.

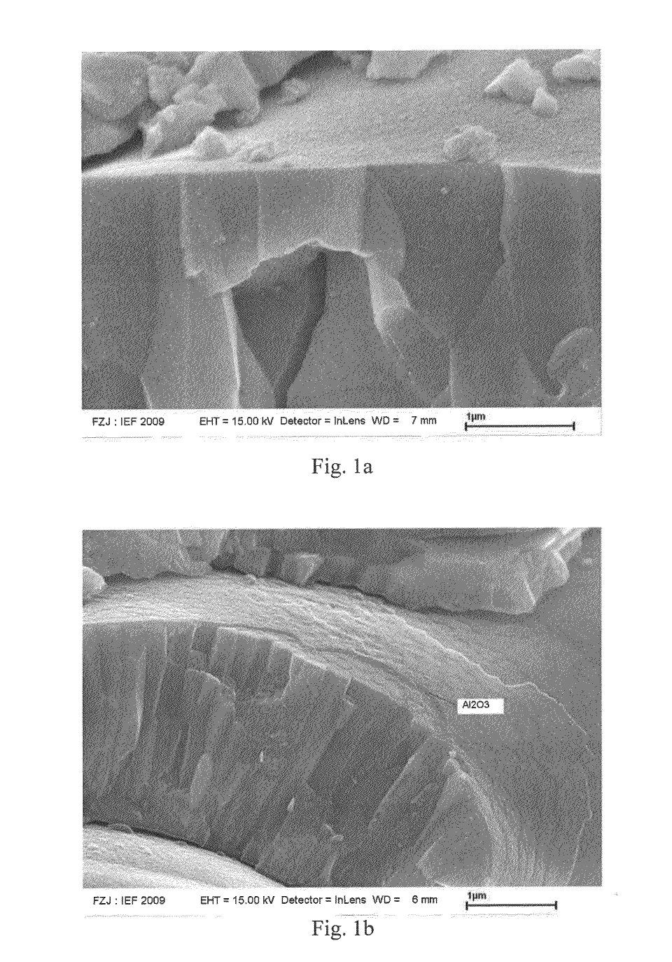

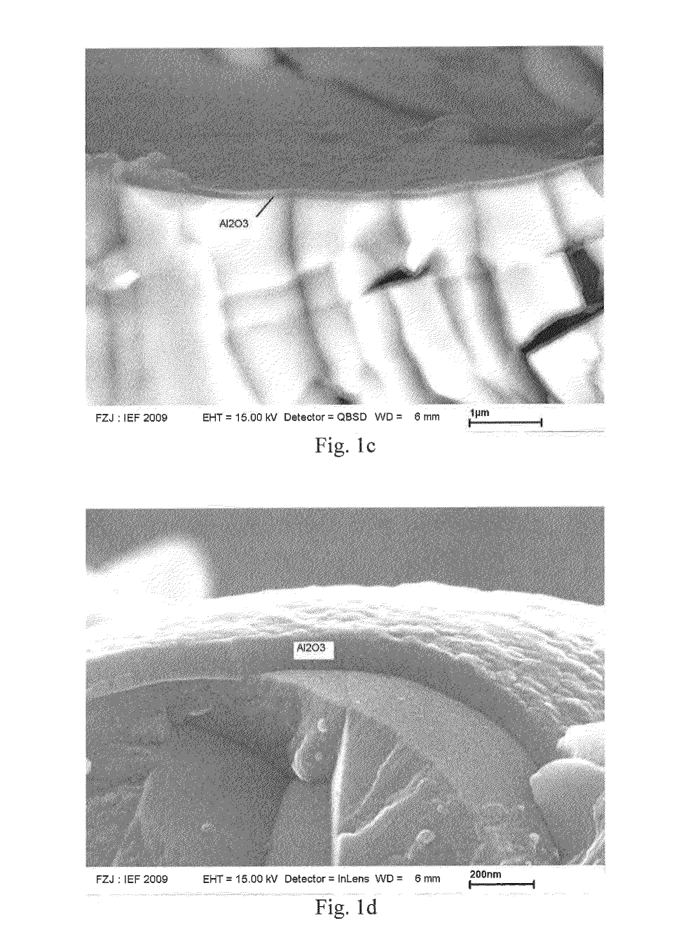

FIG. 1 shows electron-microscopic fracture surfaces of plasma-sprayed thermal insulation coatings of yttrium-stabilized zirconium oxide (YSZ). Subframe a shows a conventional coating. Subframes b through d show a coating that was internally coated using the method according to the invention in the embodiment with two precursors with Al₂O₃ as the hardening material. In temperature stress tests, it was seen that with the amount of hardening material used, which was tiny in relation to the base material, a drastic improvement in temperature stability was already successfully achieved.

One measure of temperature resistance is the sintering shrinkage. The more constant the dimensions of a functional coating remain at a given temperature profile, the less that the shrinkage suffered due to clogging of the pores is, and the stronger that the functional coating is.

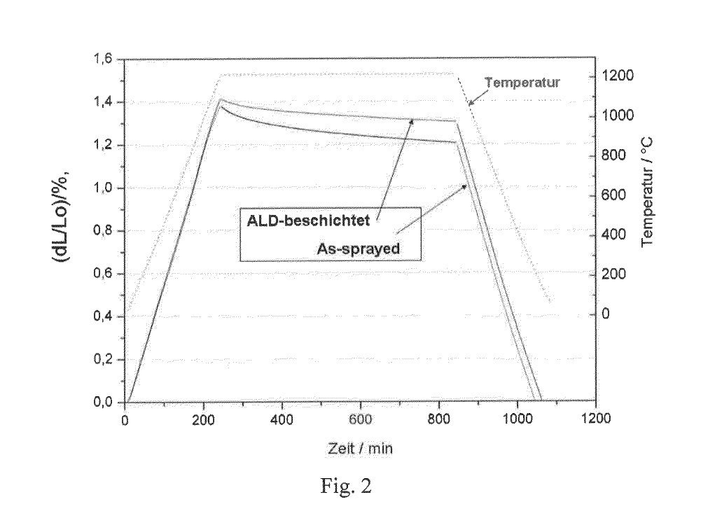

FIG. 2 shows the length change of a conventional exposed thermal insulation coating of yttrium-stabilized zirconium dioxide (YSZ) (curve a) measured with a dilatometer and the length change of an identical thermal insulation coating (curve b) that was subsequently internally coated with Al₂O₃ using the method according to the invention. Both thermal insulation coatings were exposed to the same temperature-time profile (curve c). Upon heating to 1400° C., the length of both coatings initially increased based on their thermal expansion. During the ten-hour dwell time, both coatings then transitioned to sintering shrinkage. This shrinkage is advantageously reduced in the thermal insulation coating hardened according to the invention in comparison to the conventional coating.

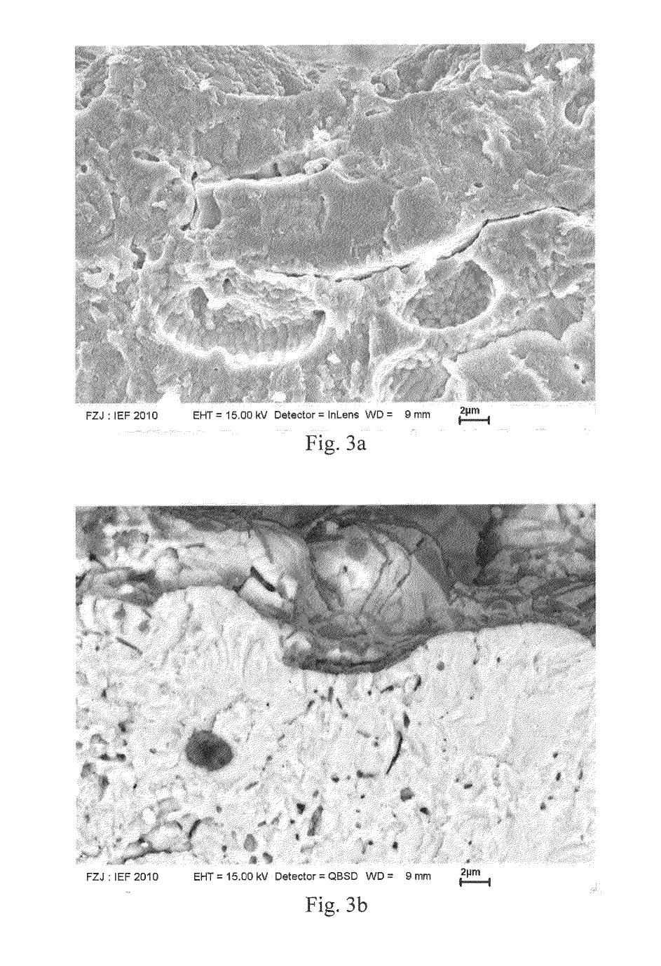

FIG. 3 shows fracture surfaces of coatings aged at 1400° C. for 10 hours. Subframe a shows the conventional coating, and subframe b shows the coating hardened using the method according to the invention. In the hardened coating, inclusions of hardening material Al₂O₃ can be seen. These inclusions could only occur due to the Al₂O₃ being introduced in larger amounts and at the same time much deeper into the pore system of the base material YSZ than had been possible according to the prior art. On the one hand, the inclusions have a restricting effect on the compaction of the base material and on the motion of the grains thereof relative to one another, which further increases the temperature stability.

On the other hand, one can expect that with hardening materials that tend to diffuse less through the base material than Al₂O₃, even higher temperature stability can be achieved. For example, zirconium dioxide-based hardening materials can be deposited as pyrochlores, spinels, garnets, or Perovskites. For other functional coatings, such as dual-layers of YSZ on bond coat and a pyrochlore phase on top (G₂Zr₂O₇, La₂Zr₂O₇ or others), ((partially)-stabilized) zirconium dioxide can be used as the hardening material.

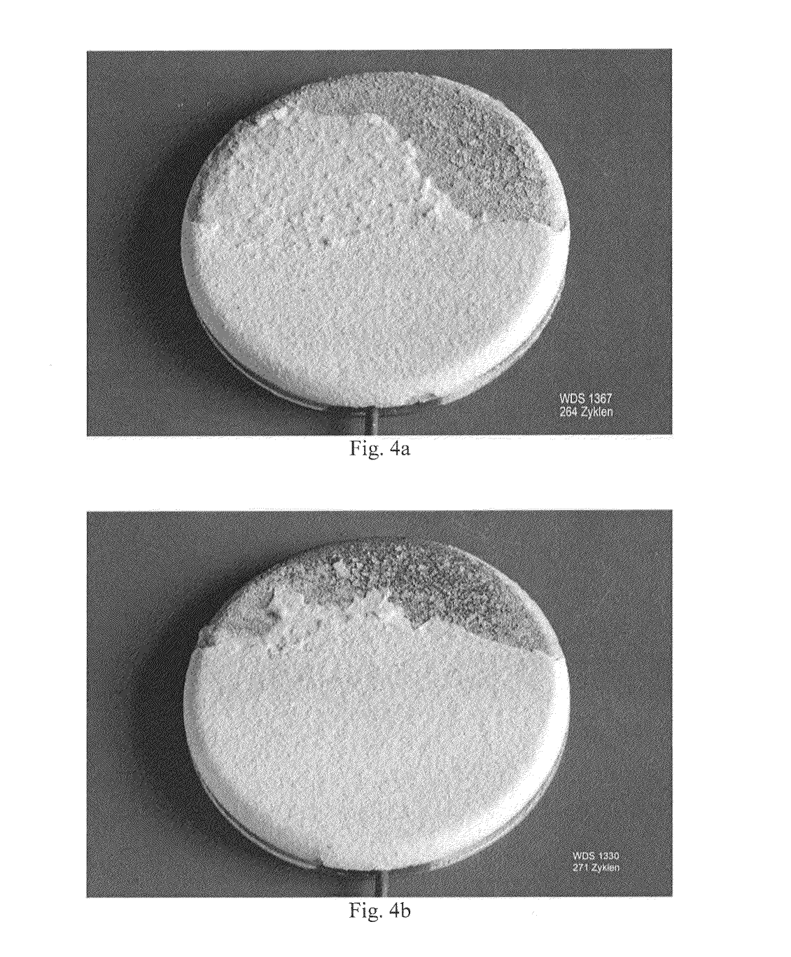

FIG. 4 shows coatings that are produced similar to the coatings tested in FIG. 2 following a cyclical gradient test in which the thermal insulation coatings were heated with a gas burner while the substrate on which the coatings were applied was simultaneously cooled. This test simulates the conditions in a gas turbine. Subframe a shows the conventional thermal insulation coating, and subframe b shows the thermal insulation coating hardened according to the method of the invention. The comparison of the two subframes shows that a much larger portion of the thermal insulation coating hardened according to the invention is still intact than the conventional thermal insulation coating.

The substrate was IN738 with a diameter of 30 mm and a thickness of 3 mm and was first provided with 150 μm of a vacuum plasma-sprayed NiCoCrAlY bond coat. Then, 300 μm of YSZ was plasma sprayed atmospherically. The coating shown in subframe a remained untreated. The coating shown in subframe b was hardened according to the invention. In the process. Al₂O₃ was used as the hardening material and 150 coating cycles were processed.

The coatings were each exposed to average surface temperatures of 1370° C. The substrate below the coating shown in subframe a had an average temperature of 1044° C.; the substrate below the coating shown in subframe b had an average temperature of 1049° C.

To test durability, a thermocycling test was performed in which the coatings were heated for 5 min and cooled for 2 min in each cycle. The coating shown in subframe a passed through 264 cycles and the coating shown in subframe b passed through 271 cycles before the coating failed.

Some details concerning the manufacturing conditions of a variety of coatings from CVD methods are shown below. Other coating materials can also be used by selecting suitable precursors.

A. YSZ with ALD

Here, mostly fully-stabilized YSZ is used for SOFCs for various applications in electronics (such as barrier coatings, storage elements). Also, pure ZrO₂ can be produced using only Zr precursors.

Suitable Precursors;

PA: ZrCl₄
and yttrium tris(2,2,6,6-tetramethyl-3,5-heptanedionate)
Y(OCC(CH₃)₃CHCOC(CH₃)₃)₃

PB: H₂O

PA: Zirconium tetrakis(2,2,6,6-tetramethyl-3,5-heptanedionate)
Zr(OCC(CH₃)₃CHCOC(CH₃)₃)₄
or zirconium acetylacetonate Zr(C₆H₇O₂)₄
or zirconium bis(cyclopentadienyl)dimethyl (C₅H₅)₂Zr(CH₃)₂
and yttrium tris(2,2,6,6-tetramethyl-3,5-heptanedionate)
Y(OCC(CH₃)₃CHCOC(CH₃)₃)₃

PB: O₃

PA: Zirconium tetrakis(dimethylamino) Zr [N(CH₃)₂]₄
and yttrium tris(butylcyclopentadienyl) Y(C₅H₄CH₂(CH₂)₂CH₃)₃

PB: H₂O

PA: ZrCl₄
and yttrium tris(butylcyclopentadienyl) Y(C₅H₄CH₂(CH₂)₂CH₃)₃

PB: H₂O

B: Perovskite ABO₃ with MOCVD (metal organic chemical vapor deposition)

For example manganite (such as La₁₋ₓSrₓMnO₃, ferrate (such as La₁₋ₓSrₓFe_{1-y}(Co,Ni)_{y}O₃), gallate (such as La₁₋ₓSrₓGa_{1-y}(Co,Ni,Fe)_{y}O₃), cobaltite (such as La₁₋ₓSrₓCoO₃), or titanate (such as PbTiO₃, SrTiO₃, BaTiO₃) suitable precursors:

Metal β-diketonates, such as Zr(TMHD)₄, Y(TMHD)₃, TMHD=C₁₁H₁₉O₂ (tetramethyl eptanedionate), and titanium(IV) isopropoxide Ti(C₃H₇O₂)₄

C: Pyrochlores A₂B₂O₇ with MOCVD (metal organic chemical vapor deposition) for example La₂Zr₂O₇

suitable precursor:

Metal β-diketonates: Lanthanum acetylacetonate hydrate La(C₅H₇O₂)₃ and zirconium(IV) acetylacetonate Zr(C₅H₇O₂)₄ in propanoic acid (CN₃—CH₂—COOH)

Bi₂Ti₂O₇ (such as for high-frequency capacitors)

suitable precursors include:

Trimethyl bismuth Bi(CH₃)₃ and titanium(IV) isopropoxide Ti(OC₃H₇)₄ with O₂

In order for these precursors to be useful for an ALD process as well for Perovskites and pyrochlores, it is necessary to split the coating formation reactions into a series of two partial steps so that complete surface saturation by one precursor at a time can be achieved, as well as the formation of suitable surface groups for chemisorption of the other precursor, respectively.

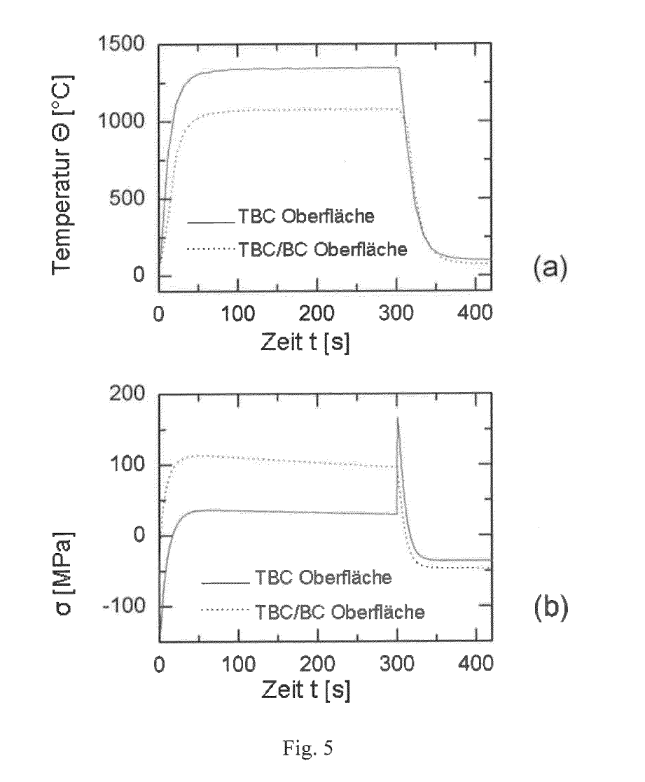

FIG. 5 shows typical temperature plots in cycling stands (top). Also seen is the stress plot (below). High tensile stresses arise in the coating, especially during cooling.

1. A method for internally coating the pores of a porous functional coating, which is made of a base material, with a hardening material that reduces the diffusion of the base material and/or the reactivity of the base material with the environment thereof, characterized in that the hardening material is deposited onto the inner surfaces of the pores from the gas phase.

2-24. (canceled)

25. A method for internally coating the pores of a porous ceramic base material with a hardening material that reduces the diffusion of the base material and/or the reactivity of the base material with the environment thereof, wherein:
the base material comprises a stabilized zirconium dioxide, a pyrochiore, a perovskite, an aluminate, a spinel or a silicate;
the base material has a porosity of at least 5 vol % and the pore distribution is such that pores having a pore diameter of less than 1 micrometer typically make up more than 40% of the porosity;
the hardening material is introduced into the pores in an inert gas stream,
the hardening material is introduced into the pores from the gas phase to depths of a multiple of the pore diameter by way of PVD; and
the pores of the porous ceramic base material are not clogged following the internal coating.

26. A method according to claim 25, wherein a thermal insulation coating, a protective coating, or a run-in coating is selected as the functional coating.

27. A method for internally coating the pores of a porous ceramic base material with a hardening material that reduces the diffusion of the base material and/or the reactivity of the base material with the environment thereof, wherein:
the base material comprises a stabilized zirconium dioxide, a pyrochlore, a perovskite, an aluminate, a spinel or a silicate;
the base material has a porosity of at least 5 vol % and the pore distribution is such that pores having a pore diameter of less than 1 micrometer typically make up more than 40% of the porosity;
the hardening material is introduced into the pores in an inert gas stream,
at least one precursor is introduced into the pores from the gas phase to depths of a multiple of the pore diameter, the precursor reacting with the base material at the internal surfaces of the pores to form the hardening material and/or decomposing there to form the hardening material, wherein the hardening material is introduced by way of AID, and wherein a metallic precursor from the group of halogens, alkyl compounds or alkoxides is used as a first as precursor PA and a non-metallic precursor from the group of water, molecular oxygen, ozone or ammonia is used as a second precursor PB; and
the pores of the porous ceramic base material are not clogged following the internal coating.

28. A method according to claim 27, wherein a thermal insulation coating, a protective coating, or a run-in coating is selected as the functional coating.

29. A porous functional coating comprising a base material with a porosity of at least 5 vol % and a pore distribution such that pores having a pore diameter of less than 1 micrometer typically make up more than 40% of the porosity, and comprising an internal coating of a hardening material that reduces the diffusion of the base material and/or the reactivity of the base material with the environment thereof, wherein:
the base material comprises a stabilized zirconium dioxide, a pyrochlore, a perovskite, an aluminate, a spinel or a silicate;
the internal coating consists of at least one monolayer of the hardening material, said monolayer reaching to depths of a multiple of the pore diameter; and
the internal coating does not clog the pores of the porous ceramic base material.

30. A porous functional coating according to claim 29, comprising a thermal insulation coating, a protective coating, or a run-in coating as the functional coating, comprising an oxide ceramic base material.

31. A porous functional coating according to claim 29, comprising fully or partially stabilized zirconium dioxide as the base material with an internal coating of Al₂O₃.

32. A porous functional coating according to claim 30, comprising fully or partially stabilized zirconium dioxide as the base material with an internal coating of Al₂O₃.
